(19) United States
(12) Patent Application Publication
(10) Pub. No.: US 2017/0255411 A1
(43) Pub. Date: Sep. 7, 2017

(54) DEVICE, DATA SAVING PROCESS METHOD AND MEDIUM FOR DATA SAVING PROCESS PROGRAM

(71) Applicant: FUJITSU LIMITED, Kawasaki-shi (JP)

(72) Inventor: Masaaki Noro, Kawasaki (JP)

(73) Assignee: FUJITSU LIMITED, Kawasaki-shi (JP)

(21) Appl. No.: 15/423,762

(22) Filed: Feb. 3, 2017

(30) Foreign Application Priority Data
Mar. 4, 2016 (JP) 2016-042536

(51) Int. Cl. G06F 3/06; G06F 1/32

(52) U.S. Cl. CPC G06F 3/0625; G06F 3/0688; G06F 3/065; G06F 3/0619; G06F 1/3287

(57) ABSTRACT

A pre-copy creator creates a copy of a memory area that is used by an application that is switched to a background and updates a memory management table. At a time of transition to a hibernation mode, an uncopied-area saving unit refers to the memory management table and creates a copy of a memory area that is used by the application and excludes the memory area of which the copy has been created by the pre-copy creator.

### CROSS-REFERENCE TO RELATED APPLICATION

This application is based upon and claims the benefit of priority of the prior Japanese Patent Application No. 2016-042536, filed on Mar. 4, 2016, the entire contents of which are incorporated herein by reference.

### FIELD

The embodiments discussed herein are related to a device, a data saving process method, and a computer-readable recording medium storing therein a data saving process program.

### BACKGROUND

The period of the idle mode of a smart device, such as a smartphone or a smart watch, is longer than the time during which the smart device runs. For example, a smartwatch runs in limited occasions, for example, when the smartwatch is notified of an event by a smartphone or when the user changes the setting, and is in the idle mode in the remaining period. FIG. 12 is a diagram for explaining operations of a smartwatch.

As illustrated in FIG. 12, for example, when a smartwatch 8 in a BLE (Bluetooth (trademark) Low Energy) standby idle mode receives an event from a smartphone 9, the smartwatch 8 notifies a user of the event by using, for example, vibration or LED light. The smartwatch 8 performs an operation of, for example, transferring the e-mail message according to an operation of the user and then returns to the idle mode.

As described above, the period of the idle mode of a smart device is long and therefore reducing the power consumption during the idle mode enables extension of the running time of the buttery. For this reason, there has been a technology for causing transition of the mode of a smart device from the idle mode to the hibernation mode. FIG. 13 is a diagram for explaining reduction of the power consumption by using hibernation.

As illustrated in FIG. 13, while the power consumption increases when a smart device is in an active mode, the period of the active mode is shorter than the period of the idle mode. For this reason, lowering the power consumption in the idle mode by using hibernation enables reduction of the power consumption of the smart device. In FIG. 13, “power in idle mode (old)” represents the power consumption in the idle mode in a case where hibernation is not performed and “power in idle mode (new)” represents the power consumption in the idle mode in a case where hibernation is performed.

In order to cause transition of the mode of the smart device to the hibernation mode, it is needed to save the data of the central processing unit (CPU) and the memory and to restore the saved data when the smart device enters the active mode. FIG. 14 is a diagram for explaining saving and restoring of data according to transition of the mode.

As illustrated in FIG. 14, the smartwatch 8 performs data saving process before transitioning from the active mode to the hibernation mode and, performs a data recovering process before recovering from the hibernation mode. For this reason, for hibernation, it is important to shorten the time to save data and the time to restore data as much as possible. FIG. 15 is a diagram for explaining a technology that reduces the time to save data.

As illustrated in FIG. 15, in order to shorten the time to save data, the smartwatch 8 in the active mode periodically creates, in a storage 7, a copy of the data in the memory. In the saving process, the smartwatch 8 saves, in the storage 7, only data that is changed from the last copy. By saving only data changed from the last copy in the storage 7 as described above, the smartwatch 8 is able to shorten the time to save data.

For data restoration, there has been a technology in which, at a time of transition from the on-mode to the off-mode, processing data is divided according to each processing unit and is then saved and, at a time of transition from the off-mode to the on-mode, only processing data used for processing to be restarted is restored, whereby the restoration time is shortened.

There has been another technology in which the device status of a device in the idle mode is written in a non-volatile memory at appropriate times and, when a suspending process is performed, only the status of the device that is not stored is stored, whereby the time taken to store the status is shortened.

There has been still another technology in which data stored in a random access memory (RAM) is written in a flash memory periodically according to the elapsed time from the latest writing or according to the importance of the data in the RAM, which enables longer use of the flash memory. There has been still another technology in which the update data in the flash memory is divided into higher data that is less frequently changed and lower data that is frequently changed and, when the same data is stored with respect to the higher data, writing is not performed, which shortens the time to perform writing and inhibits the life from shortening.

Patent Document 1: Japanese Laid-open Patent Publication No. 2009-104320

Patent Document 2: Japanese Laid-open Patent Publication No. 11-134075

Patent Document 3: Japanese Laid-open Patent Publication No. 10-133940

Patent Document 4: Japanese Laid-open Patent Publication No. 2014-215628

The conventional technology of creating a copy of the data in a memory periodically in a storage in an active mode in order to shorten the time to save data has a problem in that the number of times of writing in the storage increase and thus the life of the storage, such as a flash memory, shortens.

### SUMMARY

According to an aspect of an embodiment, a device includes a processor that executes a process including: first creating, in a non-volatile storage device, a copy of a memory area that is used by an application that is switched to a background; and at a time of transition to a hibernation mode, second creating, in the non-volatile storage device, a copy of a memory area that is used by a normal application and excludes the memory area of which the copy has been created at the first creating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining data saving and data restoration according to a first embodiment;

FIG. 2 is a diagram of a functional configuration of a smart device according to the first embodiment;

FIG. 3 is a diagram of an exemplary memory management table;

FIG. 4 is a flowchart of a flow of a process performed by a pre-copy creator;

FIG. 5 is a flowchart of a flow of a process performed by an uncopied area saving unit;

FIG. 6 is a flowchart of a flow of a process performed by an area-to-be-saved choosing unit;

FIG. 7 is a diagram for explaining data saving and data restoration according to a second embodiment;

FIG. 8A is a first diagram for explaining swap and hibernation;

FIG. 8B is a second diagram for explaining swap and hibernation;

FIG. 9 is a diagram of a functional configuration of a smart device a according to the second embodiment;

FIG. 10 is a flowchart of a flow of a process performed by the uncopied area saving unit;

FIG. 11 is a diagram of a hardware configuration of a computer that executes data saving process programs according to the first and second embodiments;

FIG. 12 is a diagram for explaining operations of a smartwatch;

FIG. 13 is a diagram for explaining reduction of power consumption by using hibernation;

FIG. 14 is a diagram for explaining data saving and data recovery; and

FIG. 15 is a diagram for explaining a technology that shortens the time to save data.

### DESCRIPTION OF EMBODIMENTS

Preferred embodiments of the present invention will be explained with reference to accompanying drawings. Note that the embodiments do not limit the technology disclosed herein.

### [a] First Embodiment

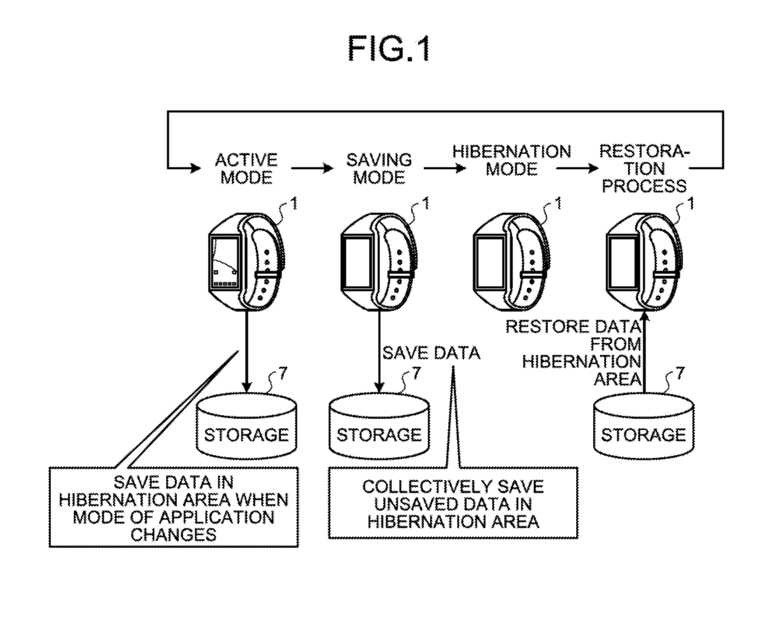

First, data saving and data restoration performed by a smart device according to a first embodiment will be described. FIG. 1 is a diagram for explaining data saving and data restoration performed by the smart device according to the first embodiment. FIG. 1 illustrates a smartwatch as an exemplary smart device.

As illustrated in FIG. 1, a smart device 1 according to the first embodiment in an active mode saves data in a hibernation area when the mode of an application changes. The application refers to an application that is executed by the smart device 1. The hibernation area is an area in which the data of the CPU and the memory is saved when the smart device 1 transitions to the hibernation mode and is an area in the storage 7. The storage 7 is a non-volatile storage device having a limit on the number of times of writing and is, for example, a flash memory.

When the application switches from a foreground to a background, the smart device 1 saves, in the hibernation area, the data of the memory area that is used by the application. The foreground refers to a mode where a screen that is output by the application is displayed on a display device and the background refers to a mode where the screen that is output by the application is not displayed on the display device. The data of the memory area that is used by the application contains the program code of the application.

The background application stays in the memory but is not executed. For this reason, when the time from when the smart device 1 is started lengthens, there is a large volume of memory area secured by the application in the hibernation mode. The memory area that is secured by the application in the hibernation mode does not change unless the application is switched or the application is forcibly terminated. Accordingly, the data of the memory area that is used by the background application is saved in advance and is not updated and therefore, at a time of transition to the hibernation mode, data saving is not needed.

For this reason, the smart device 1 collectively saves only unsaved data in the hibernation area in the saving process at a time of transition to the hibernation mode. The smart device 1 restores the data of the hibernation area in the restoration process at a time of its recovery from the hibernation mode.

In this manner, when the application is switched from the foreground to the background, the smart device 1 saves, in the storage 7, the data of the memory area that is used by the application. Accordingly, compared to the case where the data of the memory is saved periodically, the smart device 1 is able to reduce the number of times of writing in the storage 7.

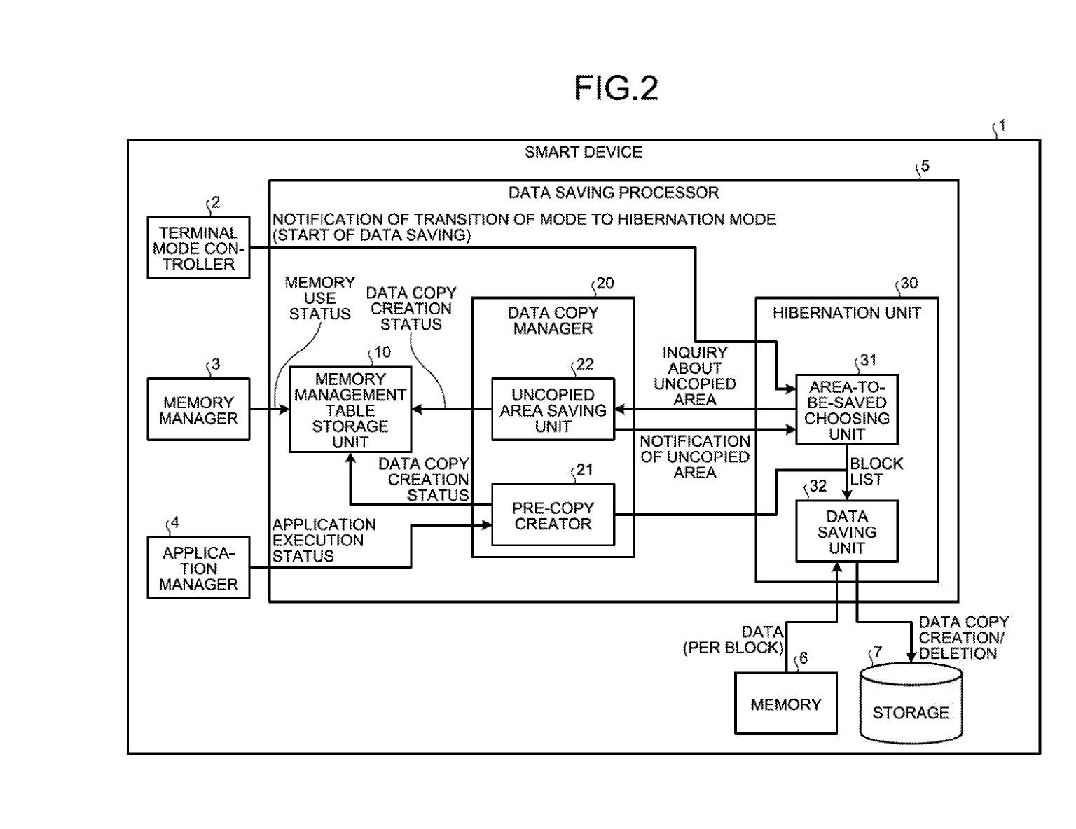

The functional configuration of the smart device 1 according to the first embodiment will be described here. FIG. 2 is a diagram of the functional configuration of the smart device 1 according to the first embodiment. As illustrated in FIG. 2, the smart device 1 includes a terminal mode controller 2, a memory manager 3, an application manager 4, and a data saving processor 5.

The terminal mode controller 2 manages the mode of the smart device 1. The mode of the smart device 1 includes an active mode and a hibernation mode. When the mode of the smart device 1 transitions to the hibernation mode, the terminal mode controller 2 notifies a hibernation unit 30, which will be described below, of the transition to the hibernation mode.

The memory manager 3 manages a memory 6 per block. The memory manager 3 creates a memory management table, which will be described below. The application manager 4 manages the mode of the application. The application manager 4 starts and ends the application and switches the application between the foreground and the background, i.e., the application manager 4 is in charge of entire control on the application. The application manager 4 notifies a pre-copy creator 21, which will be described below, of the status of execution of the application.

The data saving processor 5 performs processing related to saving of the data that is stored in the memory 6 in the storage 7. The data saving processor 5 includes a memory management table storage unit 10, a data copy manager 20, and the hibernation unit 30.

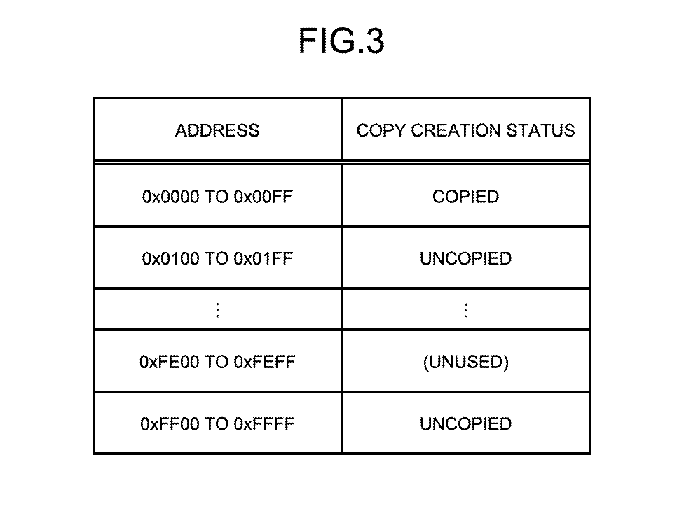

The memory management table storage unit 10 stores a memory management table in which information for managing the status of the memory 6 with respect to each block is registered. FIG. 3 is a diagram of an exemplary memory management table. As illustrated in FIG. 3, in the memory management table, an address and a copy creation status are associated with each other with respect to each block. The address represents the top address and the last address of the block.

The copy creation status represents whether a copy of the block is created in the storage 7, and “copied” represents that a copy of the block is created in the storage 7 and “uncopied” represents that no copy of the block is created in the storage 7. With respect to a block that is not used, “(unused)” is used as the copy creation status.

The data copy manager 20 manages creation of a copy of the data stored in the memory 6 in the storage 7. The data copy manager 20 includes a pre-copy creator 21 and an uncopied-area saving unit 22.

When the smart device 1 is in the active mode, the pre-copy creator 21 creates a copy of the memory area that is used by the application switched to the background and then sets “copied” for the copy creation status that is associated in the memory management table with a block contained in the memory area of which the copy is created.

The pre-copy creator 21 also deletes a copy of the memory area that has been used by an ended application from the storage 7 and sets “unused” for the copy creation status that is associated in the memory management table with a block that is freed by the ended application. The pre-copy creator 21 sets “uncopied” for the copy creation status that is associated in the management table with a block contained in the memory area that is used by the application switched to the foreground.

The uncopied-area saving unit 22 refers to the memory management table and, with respect to a block regarding which the copy creation status is “uncopied”, when the smart device 1 transitions to the hibernation mode, notifies an area-to-be-saved choosing unit 31 of an uncopied area to create a copy of the block.

The hibernation unit 30 creates a copy of a block of the memory 6 according to an instruction of the data copy manager 20. The hibernation unit 30 also deletes a copy that is created in the storage 7 according to an instruction of the data copy manager 20. The hibernation unit 30 includes the area-to-be-saved choosing unit 31 and a data saving unit 32.

On receiving a notification of transition of the mode to the hibernation mode from the terminal mode controller 2, the area-to-be-saved choosing unit 31 makes an inquiry to the uncopied-area saving unit 22 about an uncopied area. The uncopied-area saving unit 22 having received the inquiry refers to the memory management table and notifies the area-to-be-saved choosing unit 31 of the uncopied area.

Specifically, the uncopied-area saving unit 22 notifies the area-to-be-saved choosing unit 31 of a list of blocks regarding which the copy creation status in the memory management table is “uncopied”. On receiving the notification of the uncopied area, the area-to-be-saved choosing unit 31 passes the notification as a list of blocks of which copies are to be created to the data saving unit 32.

On receiving the block list of blocks of which copies are to be created from the area-to-be-saved choosing unit 31, the data saving unit 32 reads the data of the blocks that is listed up in the block list from the memory 6 and writes the data in the storage 7.

Furthermore, on receiving a block list of blocks of which copies are to be created from the pre-copy creator 21, the data saving unit 32 reads the data of the blocks listed up in the block list and writes the data in the storage 7. Furthermore, on receiving a block list of blocks of which copies are to be deleted from the pre-copy creator 21, the data saving unit 32 deletes the data of the blocks listed up in the block list from the storage 7.

The hibernation unit 30 saves data in the register of the CPU etc., in the storage 7 when the smart device 1 transitions to the hibernation mode and restores the data in the register of the CPU etc. when the smart device 1 recovers from the hibernation mode.

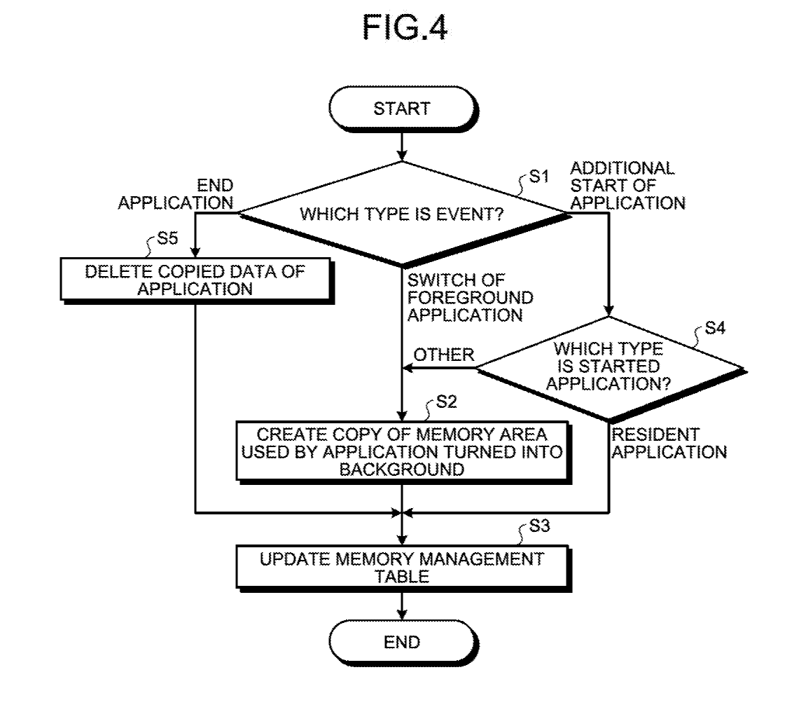

The flow of the process performed by the pre-copy creator 21 will be described here. FIG. 4 is a flowchart of the flow of the process performed by the pre-copy creator 21. As illustrated in FIG. 4, on receiving the application execution status as an event from the application manager 4, the pre-copy creator 21 determines which event type the event is (step S1).

When the event type is determined to be switching of the foreground application, the pre-copy creator 21 creates a copy of a memory area that is used by the application turned into the background (step S2) and updates the memory management table (step S3).

When the event type is additionally starting an application, the pre-copy creator 21 determines which type the started application is (step S4). When the type of the started application is a resident application, there is no application to be switched to the background and therefore the pre-copy creator 21 proceeds to step S3. On the other hand, when the type of the started application is not the resident application, there is an application to be switched to the background and therefore the pre-copy creator 21 proceeds to step S2.

When the event type is ending of an application, the pre-copy creator 21 deletes the copied data of the application (step S5) and proceeds to step S3.

As described above, the pre-copy creator 21 creates in advance a copy of the memory area that is used by the application turned into the background, and accordingly the smart device 1 is able to shorten the time to save data when transitioning to the hibernation mode.

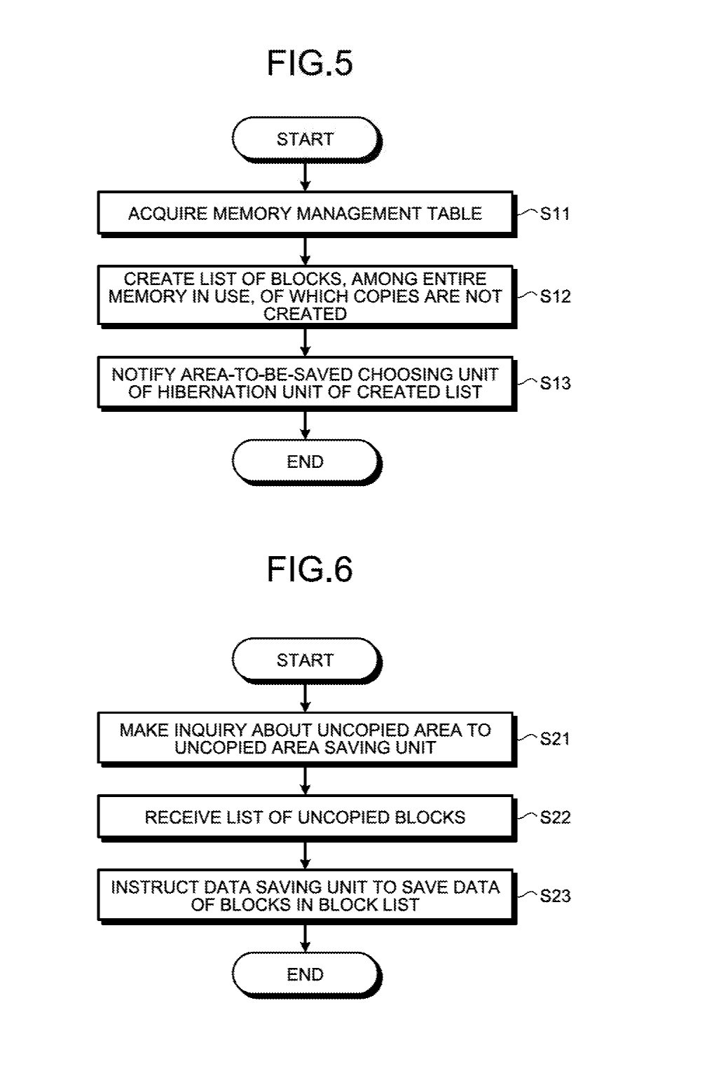

The flow of the process performed by the uncopied area saving unit 22 will be described here. FIG. 5 is a flowchart of the flow of the process performed by the uncopied area saving unit 22. As illustrated in FIG. 5, the uncopied area saving unit 22 acquires a memory management table (step S11) and creates a list of blocks, among the entire memory in use, of which copies are not created (step S12). The uncopied area saving unit 22 then notifies the created list as an uncopied area notification to the area-to-be-saved choosing unit 31 of the hibernation unit 30 (step S13).

As described above, the uncopied area saving unit 22 creates the list of blocks of which copies are not created and transmits the created list to the area-to-be-saved choosing unit 31, and accordingly the area-to-be-saved choosing unit 31 is able to specify, for the data saving unit 32, a block whose data is to be saved.

The flow of the process performed by the area-to-be-saved choosing unit 31 will be described here. FIG. 6 is a flowchart of the flow of the process performed by the area-to-be-saved choosing unit 31. As illustrated in FIG. 6, on receiving a notification of the mode transition to the hibernation mode, the area-to-be-saved choosing unit 31 makes an inquiry about the uncopied area to the uncopied area saving unit 22 (step S21). The area-to-be-saved choosing unit 31 receives a list of uncopied blocks (step S22) and instructs the data saving unit 32 to save the data of the blocks in the block list (step S23).

As described above, by making an inquiry about the uncopied area to the uncopied area saving unit 22, the area-to-be-saved choosing unit 31 is able to acquire the list of blocks whose data is to be saved.

As described above, in the first embodiment, the pre-copy creator 21 creates a copy of a memory area that is used by the application switched to the background and updates the memory management table. At a time of transition to the hibernation mode, the uncopied area saving unit 22 refers to the memory management table and creates a copy of a memory area, among the memory area used by the application, excluding the memory area of which the copy is created by the pre-copy creator 21. Accordingly, the smart device 1 is able to reduce frequency of writing in advance a copy of a memory area used by the application in the storage 7 and inhibit the life of the storage 7 from shortening.

According to the first embodiment, the pre-copy creator 21 determines that there is an application that is switched to the background when a new application other than the resident application is started or the foreground application is switched. Accordingly, the pre-copy creator 21 is able to accurately determine an application that is switched to the background.

### [b] Second Embodiment

The case where a copy of the memory data is created in the hibernation area in advance has been described as the first embodiment; however, a copy may be created in a swap area instead of the hibernation area. A case where a copy of the memory data is crated in a swap area in advance will be described as a second embodiment. The swap area refers to an area in the storage 7 in which, when the memory area is insufficient, the data of a part of the memory area is written in order to create a free area in the memory 6.

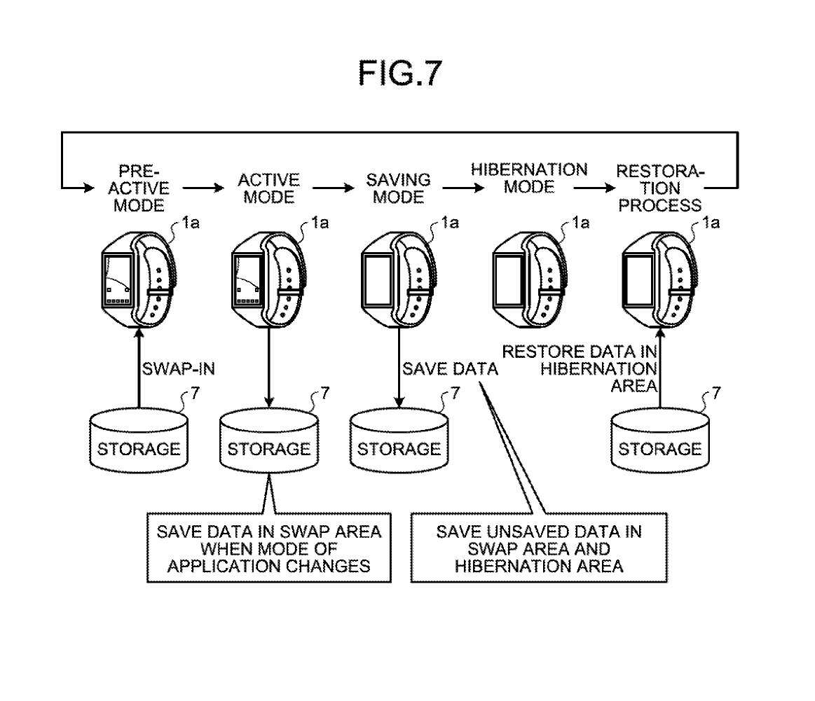

FIG. 7 is a diagram for explaining data saving and data restoration performed by a smart device according to the second embodiment. As illustrated in FIG. 7, differently from the smart device in FIG. 1, a smart device 1a according to the second embodiment has a pre-active mode and, when the mode of the application in the active mode changes, saves the data in a swap area instead of the hibernation area.

In the saving process performed when transitioning to the hibernation mode, the smart device 1a divides the unsaved data into needed data and unneeded data to restart the user processing when recovering from the hibernation mode and saves the divided data separately in the storage 7. In other words, the smart device 1a saves the data unneeded to restart the user processing when recovering from the hibernation mode in the swap area and, saves the data needed to restart the user processing when recovering from the hibernation mode in the hibernation area.

In the restoration process at a time of recovery from the hibernation mode, the smart device 1a restores only the data in the hibernation area and transitions to the pre-active mode. In the pre-active mode, the smart device 1a restarts the user processing and restores the data in the swap area by swap-in and, when all the data in the swap area is restored, transitions to the active mode.

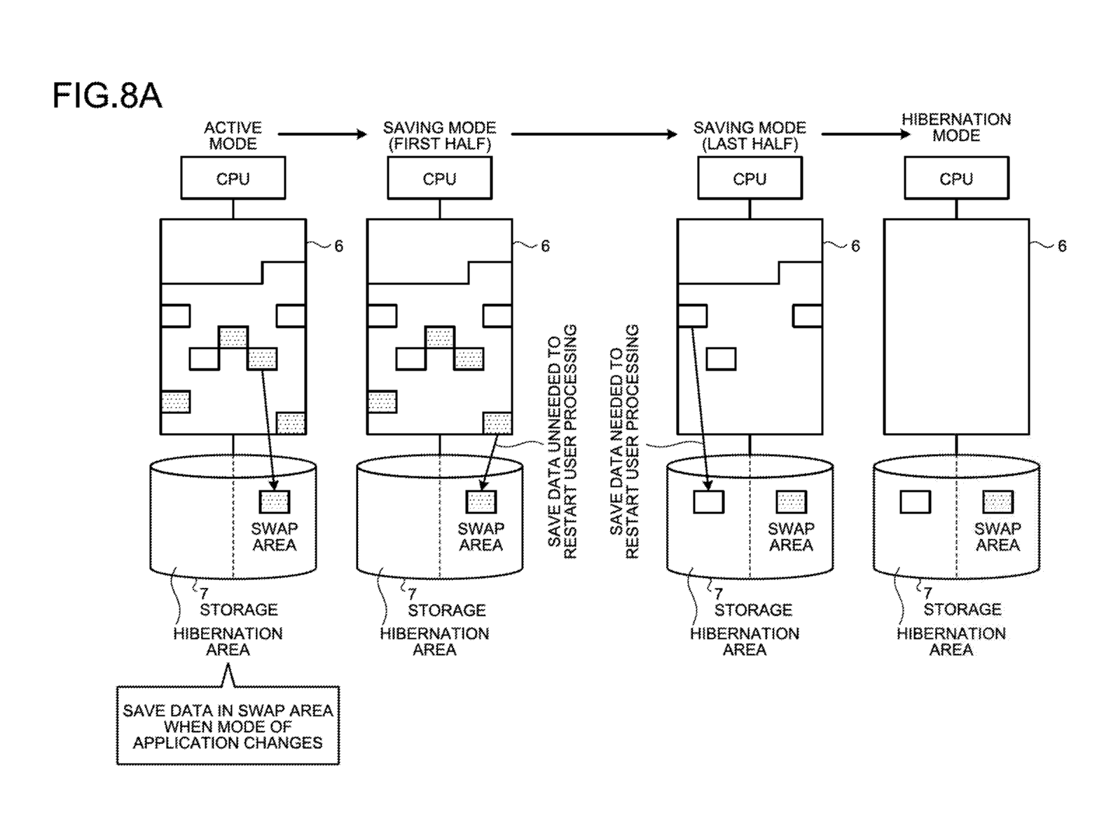

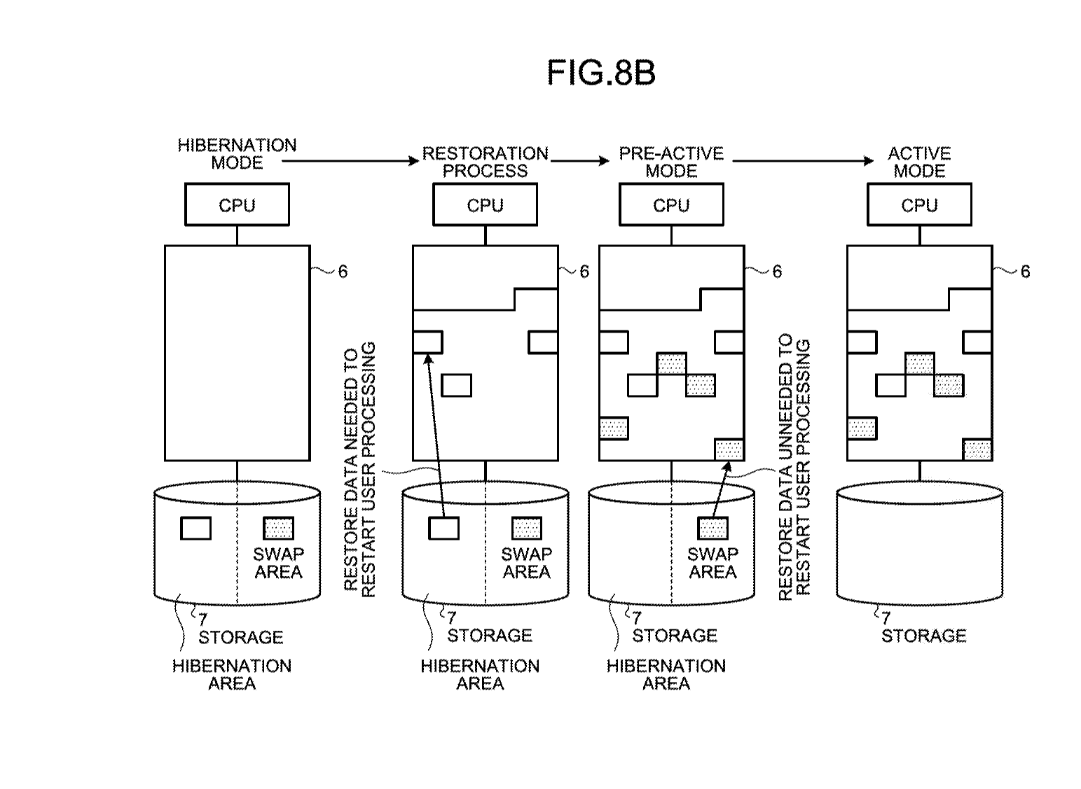

In other words, the smart device 1a performs swap and hibernation to save and restore data. FIGS. 8A and 8B are diagrams for explaining the swap and hibernation.

As illustrated in FIG. 8A, the smart device 1a in the active mode saves the data in the swap area when the mode of the application changes. The smart device 1a then saves, in the swap area, the data not needed to restart the user processing in the first half of the saving process and saves, in the hibernation area, the data needed to restart the user processing in the last half of the saving process. The smart device 1a then transitions to the hibernation mode.

As illustrated in FIG. 8B, the smart device 1a then restores the data needed to restore the user processing in the restoration process when recovering from the hibernation mode and transitioning to the pre-active mode. The smart device 1a in the pre-active mode then restarts the user processing and restores the data not needed to restart the user processing from the swap area and, when the restoration from the swap area completes, transitions to the active mode.

As described above, the smart device 1a performs swap hibernation to save and restore data and accordingly it is possible to shorten the time until the restart of the user processing when recovering from the hibernation mode.

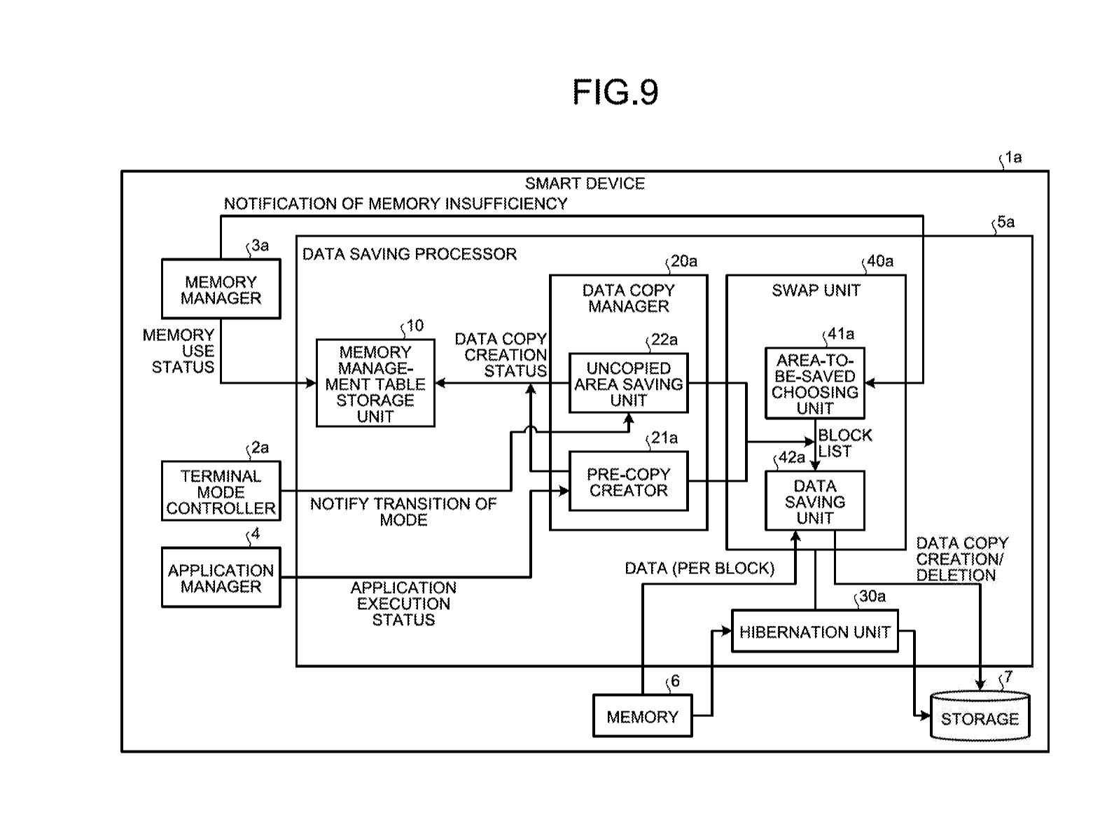

The functional configuration of the smart device 1a according to the second embodiment will be described. FIG. 9 is a diagram of the functional configuration of the smart device 1a according to the second embodiment. For the convenience of description, the functional units that play the same roles as those of the units illustrated in FIG. 2 are denoted with the same reference numbers as those in FIG. 2, and detailed descriptions thereof will be omitted below.

As illustrated in FIG. 9, differently from the smart device 1 illustrated in FIG. 2, the smart device 1a includes a terminal mode controller 2a instead of the terminal mode controller 2, includes a memory manager 3a instead of the memory manager 3, and includes a data saving processor 5a instead of the data saving processor 5.

While the terminal mode controller 2a has a similar function to that of the terminal mode controller 2, the terminal mode controller 2a notifies an uncopied area saving unit 22a of a data copy manager 20a, which will be described below, of the transition of the mode to the hibernation mode. While the memory manager 3a has a similar function to that of the memory manager 3, when the memory 6 becomes insufficient, the memory manager 3a notifies an area-to-be-saved choosing unit 41a of a swap unit 40a, which will be described below, of the insufficiency of the memory.

Differently from the data saving processor 5 illustrated in FIG. 2, the data saving processor 5a includes a data copy manager 20a instead of the data copy manager 20, includes a hibernation unit 30a instead of the hibernation unit 30, and further includes the swap unit 40a.

The data copy manager 20a manages a copy of the data of the memory 6 as the data copy manager 20 does; however the data copy manager 20a only manages the memory 6 that a normal application uses. In other words, the data copy manager 20a does not manage data of, for example, the operation system (OS), middleware, and the resident application, needed to restore the user processing.

Differently from the data copy manager 20 illustrated in FIG. 2, the data copy manager 20a includes a pre-copy creator 21a instead of the pre-copy creator 21 and includes the uncopied area saving unit 22a instead of the uncopied area saving unit 22.

While the pre-copy creator 21a has a similar function to that of the pre-copy creator 21, the pre-copy creator 21a passes a block list not to the hibernation unit 30 but to the swap unit 40a and instructs the swap unit 40a to create a copy of the blocks.

The uncopied area saving unit 22a creates a list of blocks of an uncopied area as the uncopied area saving unit 22 does but does not receive any inquiry about the uncopied area. The uncopied area saving unit 22a receives a notification of the transition of the mode to the hibernation mode from the terminal mode controller 2a and creates a list of blocks of the uncopied area. The uncopied area saving unit 22a passes the block list not to the hibernation unit 30 but to the swap unit 40a and instructs the swap unit 40a to create a copy of the blocks.

The hibernation unit 30a saves, in the storage 7, the data needed to restart the user processing including data in the register of the CPU etc. in the last half of the saving process. The hibernation unit 30a restores, from the storage 7 to the memory 6, the data needed to restart the user processing including the data in the register of the CPU etc. in the restoration process.

The swap unit 40a creates a copy of blocks of the memory 6 in the swap area of the storage 7 according to an instruction of the data copy manager 20a. The swap unit 40a includes the area-to-be-saved choosing unit 41a and a data saving unit 42a.

On receiving a notification of insufficiency of the memory from the memory manager 3a, the area-to-be-saved choosing unit 41a chooses blocks to be saved in the storage 7 and passes the list of the chosen blocks to the data saving unit 42a.

The data saving unit 42a receives the lists of blocks to be saved from the area-to-be-saved choosing unit 41a, the uncopied area saving unit 22a, and the pre-copy creator 21a and copies the data of the blocks in the lists in the swap area of the storage 7. On receiving a block list of blocks of which copies are to be deleted from the pre-copy creator 21a, the data saving unit 42a deletes the data of the blocks listed up in the block list from the storage 7.

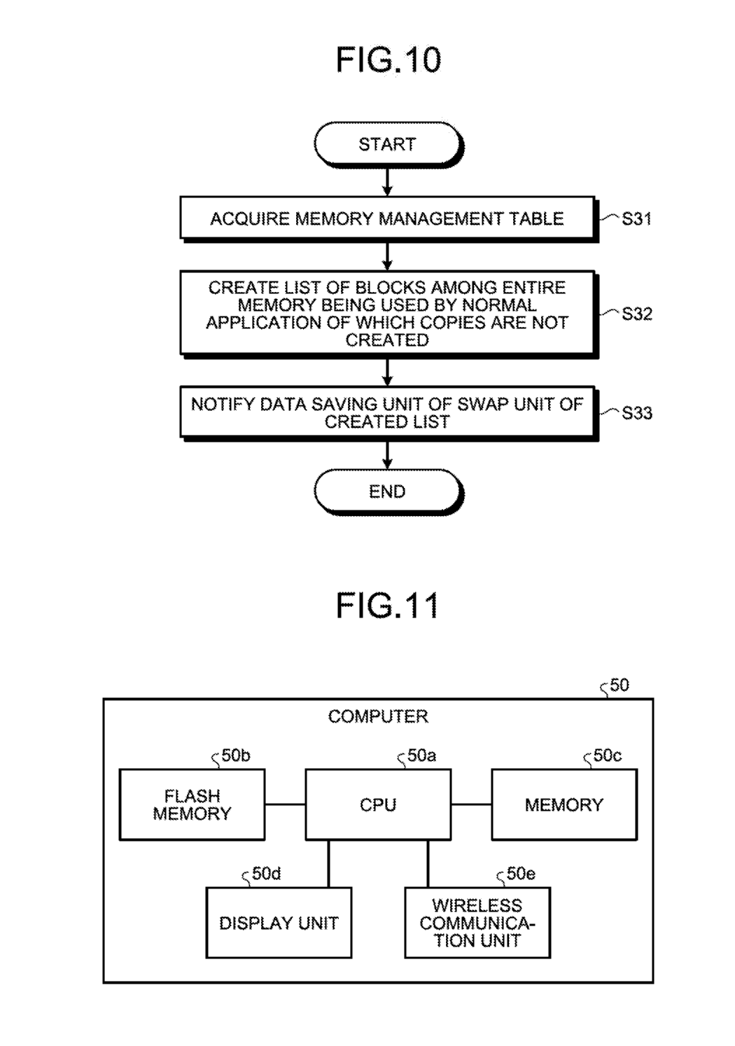

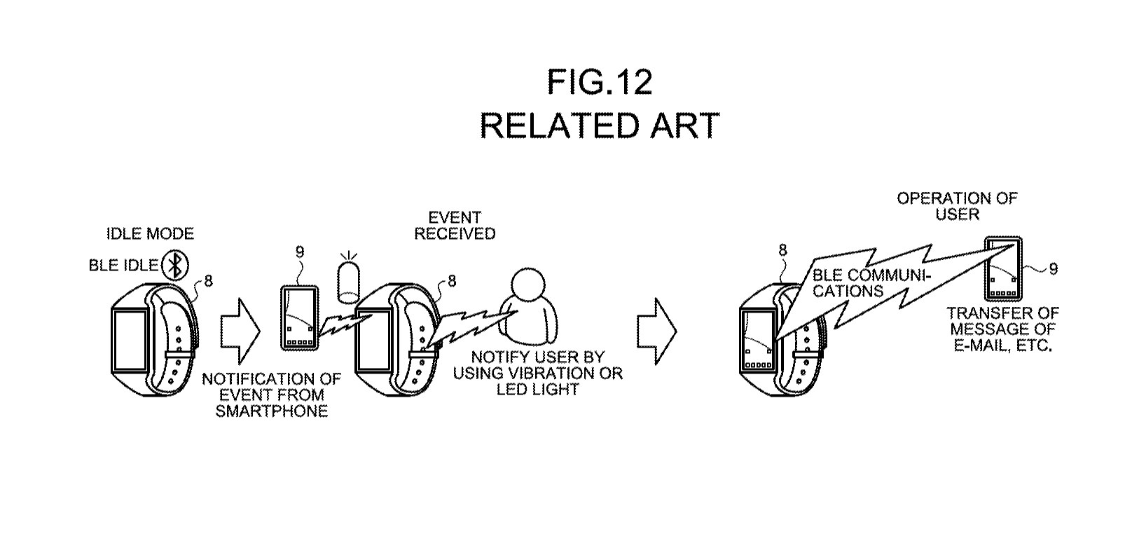

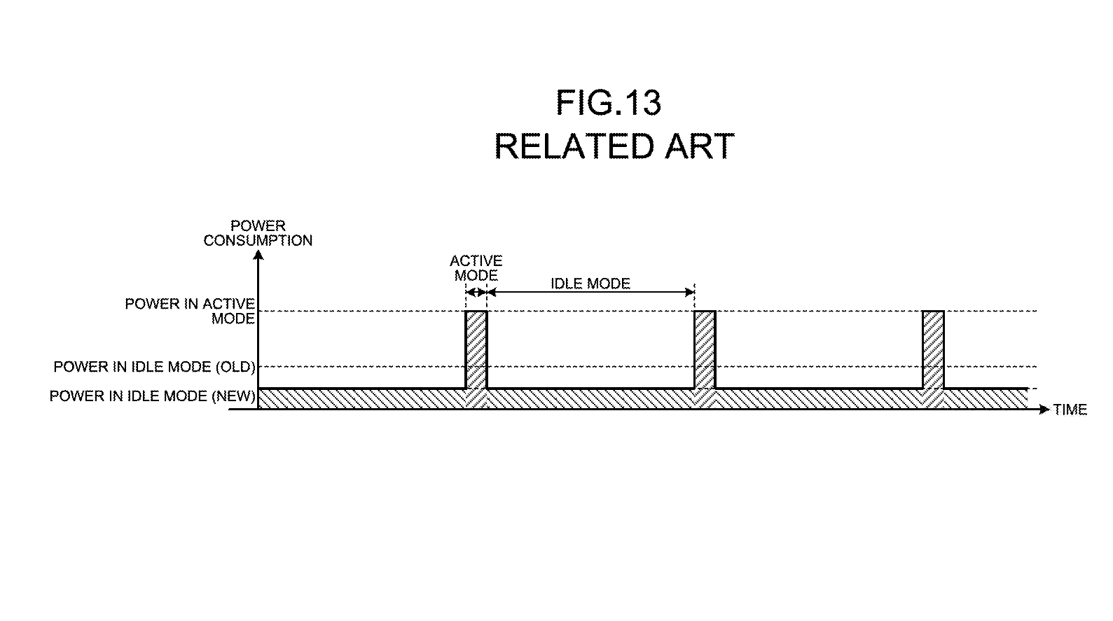

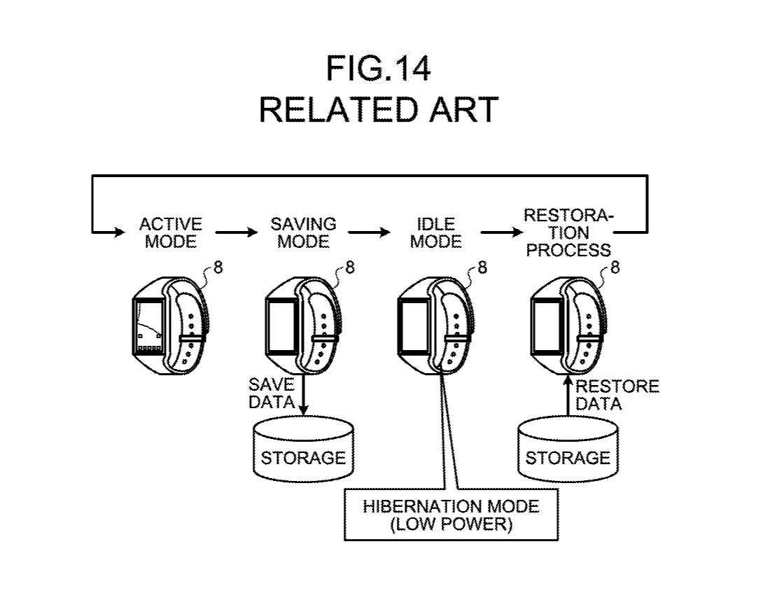

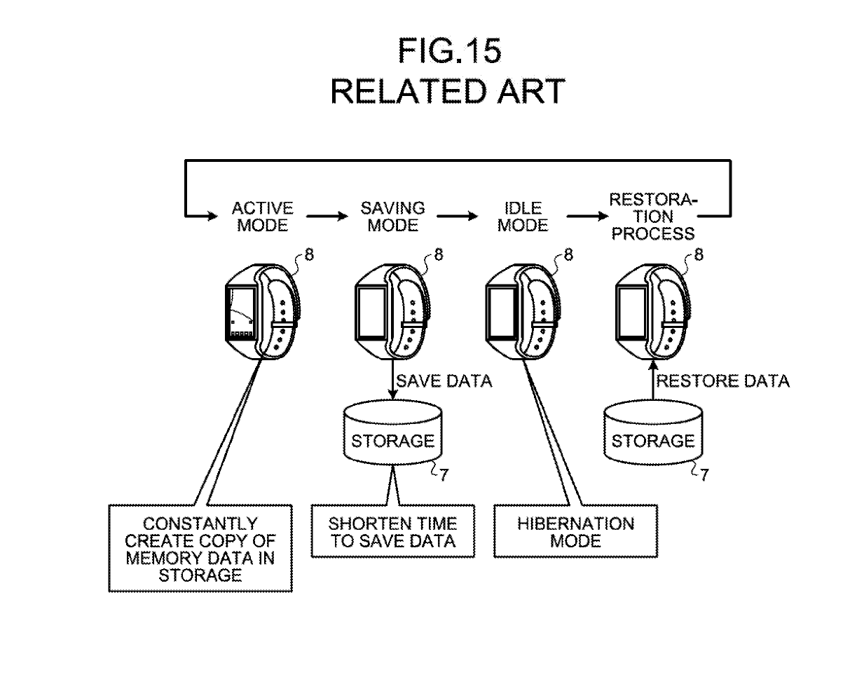

The flow of the process performed by the uncopied area saving unit 22a will be described. FIG. 10 is a flowchart of the flow of the process performed by the uncopied area saving unit 22a. As illustrated in FIG. 10, the uncopied area saving unit 22a acquires the memory management table (step S31) and creates a list of blocks among the entire memory being used by a normal application of which copies are not created (step S32). The uncopied area saving unit 22a notifies the created list as a block list to the data saving unit 42a of the swap unit 40a (step S33).

As described above, in the second embodiment, the data copy manager 20a passes the block list to the swap unit 40a and instructs the swap unit 40a to save the data. The data saving unit 42a of the swap unit 40a then creates copies of the blocks in the block list in the swap area of the storage 7. Accordingly, when recovering from the hibernation mode, the smart device 1a in the pre-active mode is able to restore the data not needed to restart the user processing and restart the user processing in a short time.

The data saving processors according to the first and second embodiments are implemented by a computer by executing data a saving process program with the same functions. The computer that executes the data saving process program will be described here.

FIG. 11 is a diagram of a hardware configuration of a computer that executes a data saving process program according to the first and second embodiments. As illustrated in FIG. 11, a computer 50 includes a CPU 50a, a flash memory 50b, a memory 50c, a display unit 50d, and a wireless communication unit 50e.

The CPU 50a is a processing device that reads and executes an application or a program, such as the data saving process program stored in the memory 50c. The flash memory 50b is a non-volatile memory that stores, for example, the application and the data saving process program. The flash memory 50b corresponds to the storage 7 illustrated in FIGS. 2 and 9.

The memory 50c is a random access memory (RAM) that stores, for example, the application and the data saving process program that are read from the flash memory 50b. The memory 50c stores, for example, the data needed to execute the data saving process program and the intermediate result of execution of the data saving process program. The memory 50c corresponds to the memory 6 illustrated in FIGS. 2 and 9.

The display unit 50d is a device that displays a screen that is output by the application and is, for example, a liquid crystal display device. The display unit 50d accepts a touch operation of the user and passes the accepted data to the CPU 50a.

The wireless communication unit 50e is a module that performs wireless communications, such as communications via a local area network (LAN), Bluetooth (trademark), and mobile phones. The wireless communication unit 50e may have multiple wireless communication functions.

According to an aspect of the embodiments, it is possible to inhibit the life of the storage from shortening.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A device comprising:
a processor configured to:
create, in a non-volatile storage device, a copy of a memory area that is used by an application that is switched to a background; and
at a time of transition to a hibernation mode, create, in the non-volatile storage device, a copy of a memory area that is used by a normal application and excludes the memory area of which the copy has been created at the first creating.

2. The device according to claim 1, wherein, when an application other than a resident application is additionally started by the processor or when a foreground application is switched, the processor is configured to create, in the non-volatile storage device, a copy of a memory area that is used by an application switched to the background.

3. The device according to claim 1, wherein the processor is configured to create copies in a hibernation area of the non-volatile storage device.

4. The device according to claim 1, wherein the processor is configured to create copies in a swap area of the non-volatile storage device.

5. The device according to claim 4, the processor is configured to create, at a time of transition to the hibernation mode, a copy of a memory area that is used and is not used by the application in the hibernation area of the non-volatile memory device.

6. A data saving process method performed by a computer, the method comprising:
creating, in a non-volatile storage device, a copy of a memory area that is used by an application that is switched to a background; and
at a time of transition to a hibernation mode, creating, in the non-volatile storage device, a copy of a memory area that is used by a normal application and excludes the memory area of which the copy has been created.

7. A non-transitory computer-readable recording medium having stored therein a program that causes a computer to execute a process comprising:
creating, in a non-volatile storage device, a copy of a memory area that is used by an application that is switched to a background; and
at a time of transition to a hibernation mode, creating, in the non-volatile storage device, a copy of a memory area that is used by a normal application and excludes the memory area of which the copy has been created.
